(19) United States
(12) Patent Application Publication
(10) Pub. No.: US 2026/0111229 A1
(43) Pub. Date: Apr. 23, 2026

(54) EXTENDED CONTROL DEVICE AND CONTROL METHOD

(71) Applicant: Mine Co., Ltd., Tokyo (JP)

(72) Inventor: Bunichiro KAMEYAMA, Tokyo (JP)

(21) Appl. No.: 19/165,777

(22) PCT Filed: Aug. 29, 2024
(86) PCT No.: PCT/JP2024/031089

§ 371 Date: Sep. 16, 2025

(51) Int. Cl. G06F 9/30; G06F 8/65

(52) U.S. Cl. CPC G06F 9/30025; G06F 8/65

(57) ABSTRACT

To provide a device and a method capable of autonomously extending and changing control even in a controller having a different command format or protocol.

The present technology includes, for example, an extended control device, which is communicably connectable to an apparatus having a control device, the extended control device comprising a central processing unit, a memory storing a predetermined control program, and a senso, wherein the central processing unit is configured to transmit the predetermined control program to the control device in response to receiving a predetermined signal from the sensor.

### TECHNICAL FIELD

The present technology relates to an extended control device that may extend control of an apparatus having a control device.

### BACKGROUND ART

In order to sell articles and provide services, such as beverages and foods, food tickets for restaurants, tickets for transportation, charging of smartphones and electric vehicles (EV), and time-based rental of parking lots in an unmanned manner, financial instruments such as vending machines, automated teller machines (ATM), money handling machines, and automated service machines (hereinafter collectively referred to as “vending system machines”) are installed inside and outside buildings, on road surfaces, in parking lots, and the like in some cases.

In order to provide new goods and services or to provide new payment instruments, a conventional vending system machine is usually replaced with a new vending system machine.

### PRIOR ART DOCUMENT

### Patent Document

Patent Document 1: Japanese Patent Application Publication No. 2000-123230

Patent Document 2: Japanese Patent Application Publication No. 2000-132737

### Non-Patent Document

Non-Patent Document 1: HACHIYOH CO., LTD., “Disaster-Handling Vending Machine”, [online], Internet <url: http://www hachiyoh.co.jp/master/products/disaster/index.html>

Non-Patent Document 2: DyDo DRINCO, Inc, “Disaster-Relief Vending Machine”, [online], Internet <url: https://www.dydo.co.jp/jihanki/saigaikyuuen/>

Non-Patent Document 3: ITOEN, LTD., “Vending Machines in Disasters”, [online], Internet, <url:https://www.itoen.co.jp/company/vender/emergency/>

### SUMMARY OF THE INVENTION

### Problem to be Solved by the Invention

An environmentally friendly and more sustainable device and method is desired that may reduce the scrapping of conventional apparatus associated with the replacement of apparatus such as vending system machines.

A device and method that can extend the functionality of conventional apparatus at low cost is desired.

A device and method that can easily and quickly expand the functionality of conventional apparatus is desired.

There is a need for a device and method that can take advantage of the reliable functionality of conventional apparatus while still providing extended functionality.

There is a need for a device and method that can be autonomously controlled even in the event of a disaster or when communication is interrupted.

A device and method that can autonomously extend and change control even in a control device having a different command format or protocol is desired.

A device and method that can remotely extend and modify the functionality of conventional apparatus is desired.

A device and method that can measure, store, and transmit information at a certain location continuously or on demand is desired.

### Means for Solving the Problem

The present technology includes, for example, an extended control device, which is communicably connectable to an apparatus having a control device, the extended control device comprising a central processing unit, a memory storing a predetermined control program, and a sensor, wherein the central processing unit is configured to transmit the predetermined control program to the control device in response to receiving a predetermined signal from the sensor.

### BRIEF DESCRIPTION OF THE DRAWINGS

FIG. 1 is a diagram illustrating an extended control system according to an embodiment of the present technology.

FIG. 2 is a diagram illustrating an extended control method according to an embodiment of the present technology.

### DETAILED DESCRIPTION OF THE INVENTION

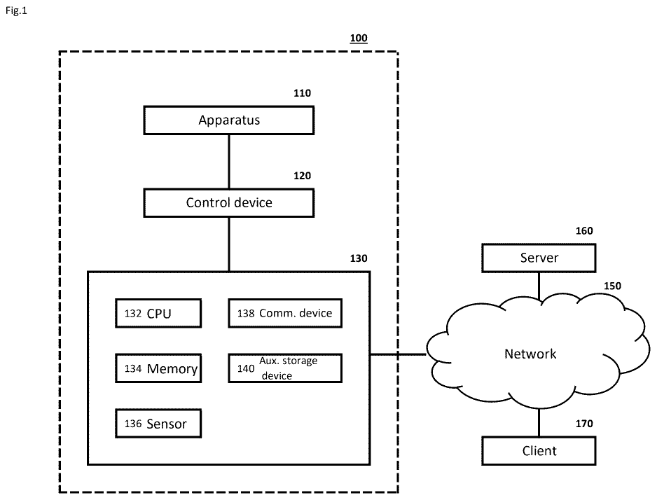

FIG. 1 illustrates an extended control system 100 in accordance with an example of the present technology. The extended control system 100 includes an apparatus 110, a control device 120, and an extended control device 130.

The apparatus 110 may be a machine to be controlled, for example, a monetary device, a storage and processing device, a vending device of a vending system machine.

The control device 120 may be a device that is communicably connected to the apparatus 110 and electrically or mechanically controls the operation or state of the apparatus 110 by a control program stored therein, and may be a programmable logic controller (PLC). The control device 120 may be, for example, an instruction device of an automatic vending system machine, and may employ a communication system and standard of a vending system machine such as JVMA or VCCS (24V serial communications) system as a communications protocol.

The extended control device 130 may be a device that is communicably connected to the apparatus 110 directly or via the control device 120 and electrically or mechanically controls the operation or state of the apparatus 110. The apparatus 110, the control device 120, and the extended control device 130 may be in the same housing, or some of them may be in different housings.

The extended control device 130 may include a central processing unit (CPU) 132, a memory 134, a sensor 136, a communication device 138, and an auxiliary storage device 140.

The CPU 132 may control the apparatus 110 by executing a control program stored in the memory 134, or may transmit the control program stored in the memory 134 to the control device 120 to be stored therein. The extended control device 130 may employ, for example, IEBus method as a communication protocol.

In a case where the control device 120 cannot interpret the control program stored in the memory 134 or a part thereof, such as a case where the protocol or the command format of the control program stored in the memory 134 is different from that of the control program stored in the control device 120, the CPU 132 may convert the protocol or the command format into a protocol or a command format that can be interpreted by the control device 120 and transmit the converted protocol or command format to the control device 120.

The memory 134 may store a control program executed by the CPU 132. The sensor 136 may be an inertial measurement unit (IMU), a seismic sensor, a GPS sensor, a heart rate sensor, a thermographic camera, a power meter, a real-time clock (RTC), or the like, or a combination thereof.

The sensor 136 may be in the same housing as the rest of the extended controller 130 or may be removably attached to the exterior of the housing of the extended controller 130.

The communication device 138 may communicatively connect the CPU 132 to a server 160, a client 170, or a terminal device such as a smartphone, via a network 150 or directly.

The auxiliary storage device 140 stores signals received by the CPU 132 from the sensors 136. The auxiliary storage device 140 may be a hard disk drive (HDD) or a solid state drive (SSD).

The network 150 may be the Internet, a local area network (LAN), a wide area network (WAN), or the like, or may be a Near Field Communication such as Bluetooth (trademark).

Server 160 includes a processor and a memory, and accepts requests from client 170 over network 150 and returns the results to client 170.

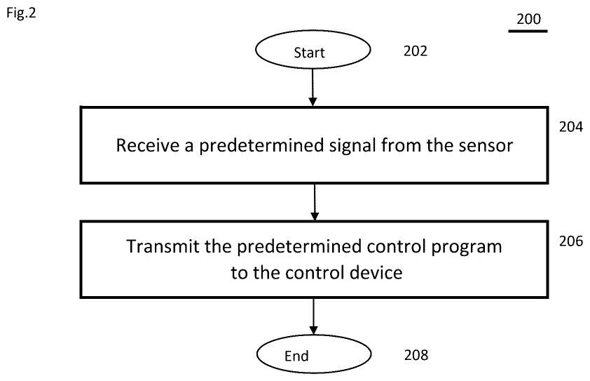

FIG. 2 illustrates an extended control method 200 according to an embodiment of the present technology.

The extended control method begins at step 202, and the CPU 132 receives a predetermined signal from the sensor 136 at step 204. The signal from the sensor 136 may be a signal indicating a measurement value by the sensor, may be a signal processed by a smart sensor or the like, or may be a non-voltage contact or a voltage contact. The signal from the sensor 136 may be received continuously, discretely (for example, once an hour), when the sensor 136 outputs a specific signal, or when the CPU 132 requests the sensor 136 to output a signal.

For example, when the sensor 136 is an inertial measurement unit (IMU), the predetermined signal from the sensor 136 may be a signal indicating that a predetermined vibration has been detected.

For example, when the sensor 136 is a seismic sensor, the predetermined signal from the sensor 136 may be a voltage free point.

For example, when the sensor 136 is a GPS, the predetermined signal from the sensor 136 may be location information measured by the GPS sensor.

For example, when the sensor 136 is a heart rate sensor, the predetermined signal from the sensor 136 may be a heart rate measured by the heart rate sensor.

For example, when the sensor 136 is a thermographic camera, the predetermined signal from the sensor 136 may be temperature distribution information measured by the thermographic camera.

For example, when the sensor 136 is a power meter or a watt-hour meter, the predetermined signal from the sensor 136 may be power consumption information or power consumption amount information measured by the power meter or the watt-hour meter.

For example, when the sensor 136 is a real-time clock, the predetermined signal from the sensor 136 may be time information measured by the real-time clock.

Next, in response to receiving the predetermined signal from the sensor in step 204, the CPU 132 transmits a predetermined control program to the controller 120 in step 206.

The reception of the predetermined signal from the sensor is not limited to a signal from a single sensor, and may be a combination of signals received from a plurality of sensors, and a response may be made when the combination of the plurality of signals satisfies a predetermined condition.

The CPU 132 may transmit a predetermined control program to the control device 120 in response to receiving a predetermined signal from the server via the communication device 138.

The CPU 132 may also transmit the predetermined signal to the server 160 via the communication device 138 in response to receiving the predetermined signal from the sensor 136.

The predetermined control program may be a control program stored in advance in the memory 134, or may be a control program received from the server 160 via the communication device 138. The control program stored in the memory 134 may be updated by receiving an update program from the server 160 via the communication device 138.

The control program may include commands or protocols that the controller 120 cannot interpret as is. In this case, the CPU 132 may convert at least a part of the set of commands of the predetermined control program into commands that can be interpreted by the control device 120 and transmit the commands, or may delete at least a part of the set of commands of the predetermined control program. The CPU 132 may convert an IEBus program into a program conforming to the JVMA or VCCS system, or may convert the IEBus program into a program so that the same functions or similar controls are realized.

In addition, in a case where the apparatus 110 is a vending system machine, a predetermined control program may switch the power supply of the vending system machine to an emergency power supply, or may switch to a sales method for disaster response such as enabling a beverage to be provided free of charge, in a case where a shake of a predetermined magnitude or more is sensed by a seismic sensor.

### INDUSTRIAL APPLICABILITY

The present technology enables control to be autonomously extended and changed even in a control device having a different command format or protocol.

### DESCRIPTION OF REFERENCE

100 Extended control system
110 Apparatus
120 Control device
130 Extended control device
132 Central processing unit (CPU)
134 Memory
136 Sensor
138 Communication device
140 Auxiliary storage device
150 Network
160 Server
170 Client

1. An extended control device, which is communicably connectable to an apparatus having a control device, the extended control device comprising:
a central processing unit;
a memory storing a predetermined control program; and
a sensor including any one of or a combination of an inertial measurement unit (IMU), a seismic sensor, a heart rate sensor, and a thermographic camera;
wherein the central processing unit is configured to transmit the predetermined control program to the control device in response to receiving a predetermined signal from the sensor.

2. The extended control device according to claim 1, wherein the central processing unit is further configured to convert the predetermined control program into commands that can be interpreted by the control device and transmit the command to the control device.

3. The extended control device according to claim 1, further comprising a communication device capable of communicating with a server connected to a network;
wherein the central processing unit is further configured to transmit the predetermined control program to the control device in response to receiving a predetermined signal from the server via the communication device.

4. The extended control device according to claim 3, wherein the central processing unit is further configured to transmit a predetermined signal to the server via the communication device in response to receiving the predetermined signal from the sensor.

5. The extended control device according to claim 1, wherein the sensor includes an inertial measurement unit (IMU) or a seismic sensor; and
wherein the predetermined signal includes a signal indicating that a predetermined vibration or earthquake has been detected.

6. The extended control device according to claim 3, wherein the sensor includes a GPS sensor; and
wherein the central processing unit is further configured to transmit position information measured by the GPS sensor to the server via the communication device.

7. The extended control device according to claim 3, wherein the sensor includes a heart rate sensor; and
wherein the central processing unit is further configured to transmit a heart rate measured by the heart rate sensor to the server via the communication device.

8. The extended control device according to claim 3, wherein the sensor includes a thermographic camera;
wherein the central processing unit is further configured to transmit temperature distribution information measured by the thermographic camera to the server via the communication device.

9. The extended control device according to claim 3, wherein the sensor further includes a power meter;
wherein the central processing unit is further configured to transmit power consumption information measured by the power meter to the server via the communication device.

10. The extended control device according to claim 3, wherein the sensor further includes a real-time clock;
wherein the central processing unit is further configured to transmit time information measured by the real-time clock to the server via the communication device.

11. The extended control device according to claim 1, wherein the apparatus comprises a vending system machine;
wherein the predetermined control program includes switching a power supply of the vending system machine.

12. The extended control device according to claim 1, wherein the apparatus includes a vending system machine;
wherein the predetermined control program includes switching a sales method of the vending system machine.

13. The extended control device according to claim 2, wherein converting the predetermined control program into commands that can be interpreted by the control device includes converting at least a part of a command set of the predetermined control program into a command set interpretable by the control device.

14. The extended control device according to claim 13, wherein converting the predetermined control program into commands that can be interpreted by the control device includes deleting at least a part of a command set of the predetermined control program.

15. The extended control device according to claim 3, wherein the central processing unit is further configured to receive a control program from the server via the communication device and store the control program in the memory.

16. The extended control device according to claim 15, wherein the central processing unit is further configured to receive an update program from the server via the communication device and update the control program stored in the memory.

17. The extended control device according to claim 1, further comprising a plurality of sensors; and
wherein the central processing unit is further configured to transmit the predetermined control program to the control device according to a combination of signals received from the plurality of sensors.

18. The extended control device according to claim 1, further comprising an auxiliary storage device; and
wherein the central processing unit is further configured to store the signal received from the sensor in the auxiliary storage device.

19. A method for controlling an extended control device, which is communicably connectable to an apparatus having a central processing unit, a memory storing a predetermined control program, a sensor including any one of or a combination of an inertial measurement unit (IMU), a seismic sensor, a heart rate sensor, and a thermographic camera, and a control device, the method comprising:
receiving a predetermined signal from the sensor by the central processing unit; and
controlling the apparatus according to the predetermined control program in response to receiving the predetermined signal.

20. (canceled)
